(19) United States
(12) Patent Application Publication
(10) Pub. No.: US 2008/0052383 A1
(43) Pub. Date: Feb. 28, 2008

(54) System and method for mobile device application management

(75) Inventors: John O'Shaughnessy, Brunton-Wiltshire (GB); Jeroen Herman Mol, Den Dolder (NL); Pieter Bastiaan Leezenberg, San Francisco, CA (US)

Correspondence Address: ST. ONGE STEWARD JOHNSTON & REENS, LLC, 986 BEDFORD STREET, STAMFORD, CT, 06905-5619, US

(73) Assignee: GPXS Holding Ltd., Addlestone-Surrey (GB)

(21) Appl. No.: 11/509,994

(22) Filed: Aug. 25, 2006

(51) Int. Cl. G06F 15/16; G06F 15/173

(52) U.S. Cl. 709/223; 709/229; 709/203

(57) ABSTRACT

A system for managing mobile electronic devices in a network, including a plurality of mobile electronic devices, at least one network processor, directory service software executing on the at least one network processor for providing user data pertaining to users of the plurality of mobile electronic devices, at least one mobility server in communication with the at least one network processor, and device management software executing on the at least one mobility server for receiving the user data and sending at least one mobile application to one or more of the plurality of mobile electronic devices based on the user data.

### FIELD OF THE INVENTION

The invention relates generally to mobile electronic devices, and more specifically to a system and method for managing applications on mobile electronic devices.

### BACKGROUND OF THE INVENTION

Mobile electronic devices, such as the Blackberry® developed by Research in Motion Limited (RIM), have become common place in a many industries and professions. Organizations generally invest in mobile devices and the associated infrastructure to increase the accessibility and effectiveness of their employees. It is therefore important that measures are taken to ensure that such mobile devices are being deployed cost-effectively and in a way that supports business goals.

Mobile electronic devices generally including any number of software applications. Such applications must be loaded on to the mobile electronic device and updated periodically. In a large organization having hundreds or thousands of mobile electronic devices, the implementation of new software or updating of existing software may be very time consuming and complicated. For example, U.S. Patent Application Publication 2006/0046717 discloses a method for providing wireless device management. The method includes a service provider receiving a request for wireless devices with specified pre-loaded software, loading the software on each individual device, delivering the devices and connecting the devices to a network. Should any changes be necessary to the pre-loaded software, the organization must send a request to the service provider. The request is evaluated by a technical specialist of the service provider and a team meets to evaluate the feasibility of the request. The service provider then contacts the service receiver to review the feasibility findings. If the request is approved, the service provider develops a configuration change and drafts a means for delivering the change.

Individual users of mobile electronic devices may also download, install or uninstall software applications on their particular device. Use of applications not authorized by the organization may negatively affect the device, create software compatibility issues and/or be in conflict with IT policies or regulatory requirements in the organization. Likewise, the erroneous or intentional deletion of software applications from an individual's mobile electronic device may inhibit the usefulness of the device.

It is therefore desired to provide an improved system and method for managing policies and applications on mobile electronic devices.

### SUMMARY OF THE INVENTION

Accordingly, it is an object of the present invention to provide a system and method for enable information technology policies to a network of wireless devices.

It is a further object of the present invention to provide a system for managing applications on mobile electronic devices which allows an organization to push software and other information to one or more groups of mobile devices.

It is a further object to provide a system for managing applications on mobile electronic devices which provides for the targeted removal of software from one or more groups of mobile devices.

It is a further object to provide a system for managing applications on mobile electronic devices able to determine software application privileges of one or more mobile devices or groups of mobile devices and update, load, and/or remove software accordingly.

These and other objectives are achieved by providing a system for managing mobile electronic devices in a network, including a plurality of mobile electronic devices, at least one network processor, directory service software executing on the at least one network processor for providing user data pertaining to users of the plurality of mobile electronic devices, at least one mobility server in communication with the at least one network processor, and device management software executing on the at least one mobility server for receiving the user data and sending at least one mobile application to one or more of the plurality of mobile electronic devices based on the user data.

Further provided is a system for managing mobile electronic devices in a network, including a plurality of mobile electronic devices, each of the mobile electronic devices including device agent software for providing device data, at least one processor, directory service software executing on the at least one processor for providing user data pertaining to users of the plurality of mobile electronic devices, and device management software executing on the at least one processor for receiving the user data and sending at least one device policy to one or more of the plurality of mobile electronic devices based on the user data.

Further provided is a method of managing mobile electronic devices in a network, including the steps of receiving user data from a directory service, the user data pertaining to at least one mobile electronic device user, determining mobile application privileges for the at least one user based on the user data, determining a device status of at least one mobile electronic device corresponding to the at least one user, and modifying one or more applications on the at least one mobile electronic device based on the mobile application privileges and the device status.

Other objects, features and advantages according to the present invention will become apparent from the following detailed description of certain advantageous embodiments when read in conjunction with the accompanying drawings in which the same components are identified by the same reference numerals.

### BRIEF DESCRIPTION OF THE DRAWINGS

FIG. 1 is schematic diagram of a system according to the present invention.

FIG. 2 is another schematic diagram of the system shown in FIG. 1.

FIG. 3 is another schematic diagram of the system shown in FIG. 1.

FIG. 4 is method for managing applications on mobile electronic devices employable by the system shown in FIGS. 1-3.

### DETAILED DESCRIPTION OF THE INVENTION

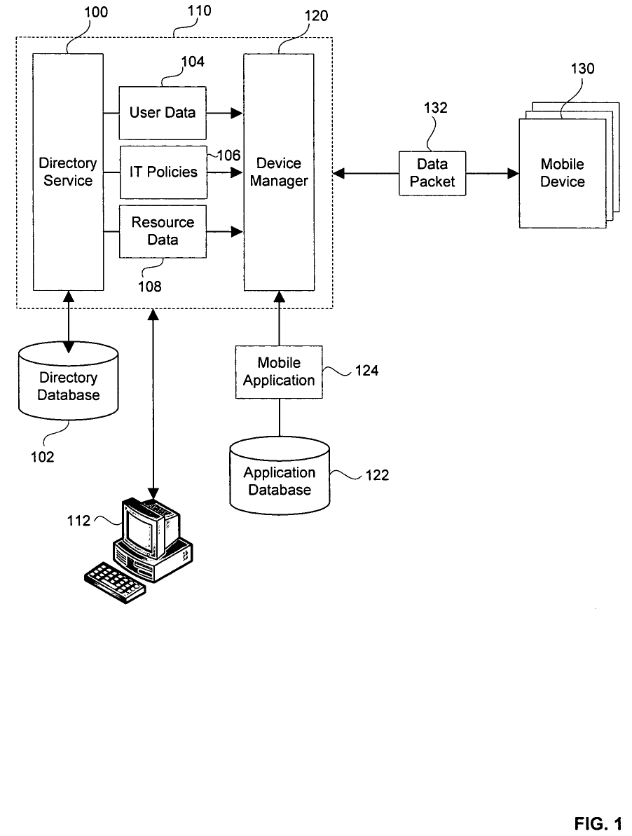

FIG. 1 shows a system for managing applications on mobile electronic devices according to the present invention. The system includes a directory service 100. The directory service 100 may be embodied in software, hardware or a combination of both. For example, the directory service 100 may be a software application that stores and structures information about an organization and/or its computer network's resources (e.g., users, groups, computers, printers, storage, etc). The directory service 100 may further store and structure information technology (“IT”) policies of the organization. In some embodiments, the directory service 100 is an implementation of Lightweight Directory Access Protocol (“LDAP”) such as Microsoft's Active Directory or any other LDAP directory service. The information, e.g., user data, resource data, IT polices, etc., is stored in one or more directory databases 102 of the system. The directory service 100 may execute on a network processor 110 and/or network server.

The system includes a plurality of mobile devices 130. The mobile devices 130 may be any mobile devices, such as mobile phones, personal digital assistants (“PDA's”), smart phones, handhelds, PocketPC's, or notebook computers. For example, the mobile devices 130 may be Blackberry® mobile devices, developed by Research in Motion Limited (“RIM”). The system further includes at least one device manager 120. The device manager 120 may be embodied in hardware, software or a combination of both. For example, the device manager 120 may be a server, and/or software executing on one, or both, of the network processor 110 and/or a mobility server. The device manager 120 may further include device management software for mobile device and application management and data synchronization to the mobile devices 130. The system also includes at least one applications database 122 in communication with the device manager 120 including a plurality of mobile applications 124.

The directory service 100 and device manager 120 of the present invention are in communication with one another and/or integrated. The directory service 100 and device manager 120 may be integrated by any means. For example, the device manager 120 may include integration software for communicating with the directory service 100. The system may further include an application programming interface (“API”) software for providing an interface between the directory service 100 and device manager 120. The API may also provide integration with other tools as well, e.g., where the device manager 120 functions are input into another program that the IT or system administrator may run. In some embodiments, the system includes user interface software providing a range of system tools (e.g., via a computer 112), e.g., using the integration between the device manager 120 and the directory service 100.

As shown, the device manager 120 may receive information from the directory service 100 pertaining to the organization's users, resources and/or policies. For example, the device manager 120 may receive user data 104, IT policies 106 and/or resource data 108 from the directory service 100. The user data 104 may include data pertaining to users (e.g., end users) of the mobile devices 130 (e.g., in an organization or corporation) including mobile application permissions for a user or a group of users. For example, the directory service 100 may provide user data 104 for a group (e.g., community) of users in an organization including data indicative of one or more mandatory mobile applications, one or more optional mobile applications and one or more prohibited mobile applications. The device manager 120 may use the information to provide data 132, instructions and/or applications to a plurality of mobile devices 130. The device manager 120 may further implement or enforce the organization's IT policies 106 on the mobile devices 130.

Any number of groups or communities may be registered by the directory service 100, e.g., for the purposes of managing mobile devices, mobile device users, mobile application software, mobile data and mobile IT policies. Furthermore, a user may be included in more than one group. In such cases, the system may determine the privileges and IT policies applicable to the particular user by specifying a group dominance hierarchy where the privileges of the more dominant group overwrite less dominant group. For example, a user may be a member of an executive personnel group and a division employee group of the organization. The system may compare the software privileges and IT policies for each group and apply those associated with the more dominant group (e.g., executive personnel). Software only provided in the less dominant group but not prohibited in the dominant group may also be provided to the user. Custom privileges and policies for a specific user may further be manually specified in the directory service 100 (e.g., by a system administrator).

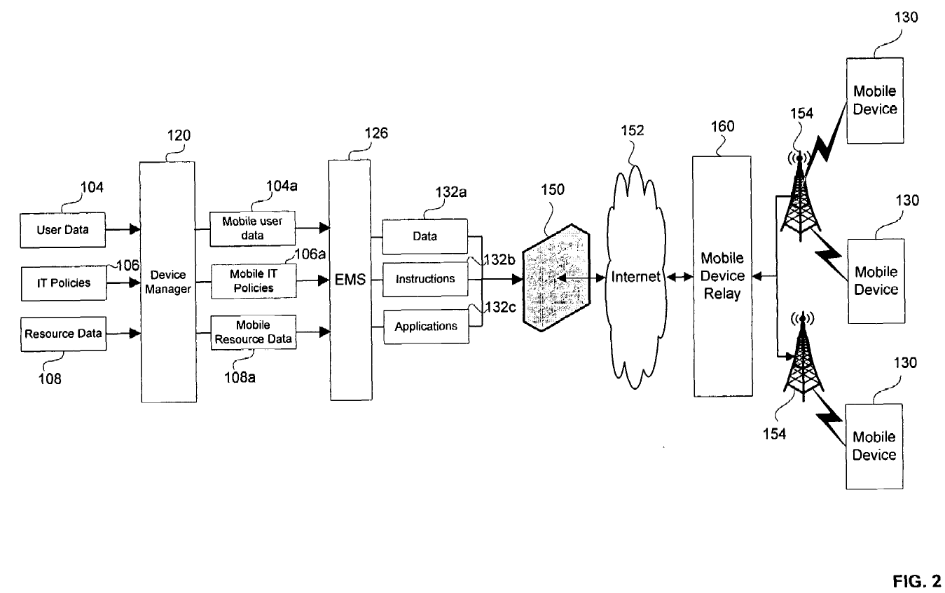

Information such as the data 132 and/or mobile applications may be sent to and from the mobile devices 130 via any communication channel and/or wireless network. FIG. 2 illustrates one particular embodiment of a means to communicate the data 132 (e.g., data 132a, instructions 132b, and/or application 132c). In the exemplary embodiment, the system includes at least one separate enterprise mobility server (“EMS”) 126, e.g., residing behind the organization's firewall 150. The EMS 126 may be embodied in hardware, software or a combination of both. In larger organizations and/or organizations having multiple locations, the system may include multiple EMS's 126 (e.g., each corresponding to a group of wireless users) in communication with the device manager 120. The EMS 126 receives user data 104a, IT policies 106a and resource data 108a from the directory service 100 and/or device manager 120. In some embodiments, some of the data 104a, policies 106a, and/or resource data 108a are already stored on the EMS 126. Information (e.g., data 132) may therefore be pushed to one or more mobile devices 130 by the EMS 126 via the Internet 152 and a wireless network 154. In some embodiments, the data 132 is further sent/received via a mobile device relay 160 (e.g., Blackberry Relay). It should be understood that FIG. 2 illustrates only one exemplary embodiment, and other embodiments may not include a separate EMS 126 or a relay 160. For example, the device manager 120 may include a push application for communicating directly with the mobile devices 130.

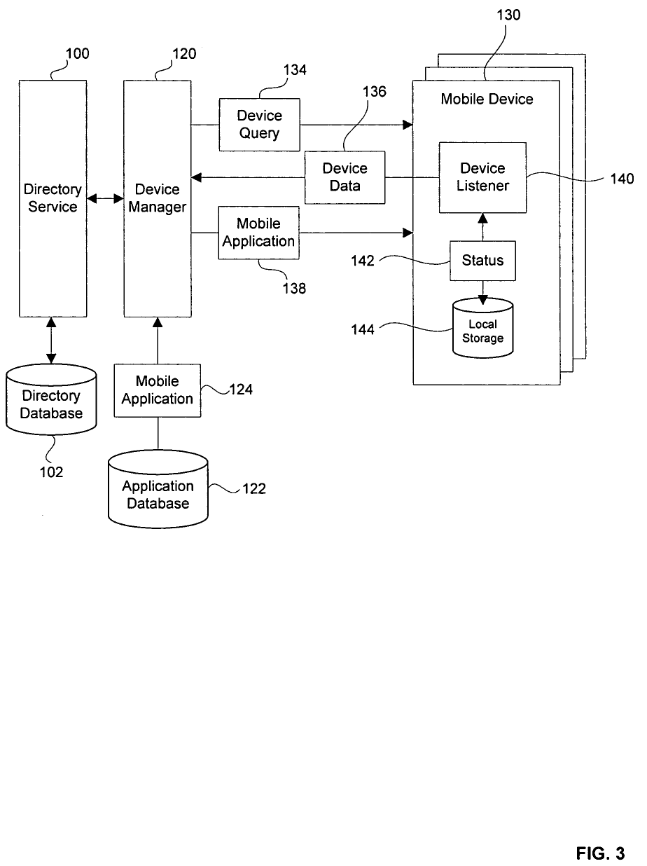

FIG. 3 shows another diagram of the system for managing applications on mobile electronic devices according to the present invention. As shown, the device manager 120 may send one or more mobile applications 138 to the mobile devices 130. For example, the device manager 120 may receive user data 104 from the directory service 100 including mobile application permissions for a group of users (e.g., software “blacklists,” “whitelists”, etc). The device manger 120 may then send or “push” (e.g., wirelessly) at least one mobile application 138 (e.g., executable file) to one or more of the plurality of mobile devices 130 corresponding to the group of users. The push of the mobile application 138 or other electronic data to a mobile device 130 or group of mobile devices may be manually initiated, event triggered, timed or automatic.

Each of the mobile devices 130 may include a device agent 140 or device agent software for communicating with the device manager 120 and performing certain functions on the mobile devices 130. Communication between each device agent 140 and the device manager 120 need not rely on any specific wireless protocol (e.g., GPRS) being available and may use different protocols (e.g., SMS, MMS, etc) if necessary.

The device agent 140 of each mobile device 130 may receive any number of device queries 134 or instructions from the device manager 120. For example, the device manager 120 may query the agent 140 on one or more mobile devices 130 for a status 142 of the mobile device (e.g., the status of a software push, log files, battery strength, signal strength or roaming status, free memory space, software, files and recent usage). The agent 140 may then provide device data 136 to the device manager 120, e.g., in response to the device query 134. The device data 136 may include the status 142 and/or a report of mobile applications executing on the mobile device 130. The device agent 140 may also send device data 136 at specified timed intervals and/or in response to an event on the mobile device 130 (e.g., a software crash or a device reboot). The device manager 120 may also generate and distribute a report on information or device data 136 received from a plurality of agents 140 (e.g., periodically or upon request).

Each agent 140 may load, delete or update applications on the mobile device 130, e.g., in response to a device query 134 and/or instruction from the device manager 120. For example, the device manager 120 may send a device query or instruction 134 including details of a set of software applications that are to be wirelessly pushed to the mobile device 130 and/or each mobile device 130 pertaining to a group of users (e.g., the timing and sequence of the wireless application push). The agent 140 may then execute the instructions accordingly. The agent 140 may also change a setting or configuration of an application or software running on the mobile device, e.g., by request from the device manager 120, at a specified time, and/or in response to an event on the device. In some embodiments, the system may determine an appropriate time to execute instructions received from the device manager 120. For example, the device agent 140 of a particular mobile device 130 may determine that the mobile device 130 is roaming and, due to the increased cost of data transfer rates, the system (e.g., device manager 120 or device agent 140) may delay an action such as a software push. If a software push is continuously delayed (e.g., requiring multiple attempts), an alert may be generated to a system administrator.

The device agent 140 according to the present invention may also receive one or more IT policies 106 from the device manager 120 and/or the EMS 126. The agent 140 may implement the IT policy on the mobile device or store the IT policy on the mobile device 130 (e.g., in a storage 144). For example, the agent 140 may implement or store a “blacklist” and/or “white list” of mobile software applications. The agent 140 may then add or delete mobile software applications accordingly, or prevent a user from loading or modifying one or more mobile software applications in accordance with the IT policy. In some embodiments, the agent 140 continuously monitors one or more mobile applications on the mobile device 130 for compliance with the IT device policy. IT policies may also be downloaded and/or implemented by a user of the mobile device 130 or system administrator. For example, the user may be directed to take an action to implement a policy, such as access a particular URL to download a file (e.g., IT policy 106).

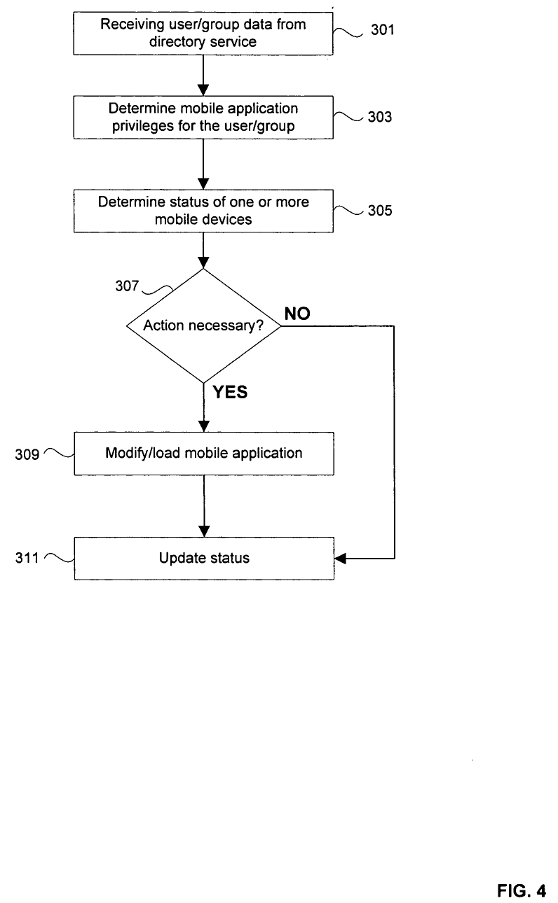

FIG. 4 shows a method for managing applications on mobile electronic devices employable by the system shown in FIGS. 1-3. The method includes a first step of receiving user data from a directory service (step 301). The user data may, for example, pertain to at least one mobile electronic device user or at least one group of users. Next, mobile application privileges are determined for the at least one user or group of users based on the user data (step 303).

A device status of at least one mobile electronic device corresponding to the at least one user may further be determined (step 305). The device status may be obtained by sending a device query and receiving the device status (e.g., via GPRS, SMS, or MMS) from a device agent application of each particular mobile device. The device status for a particular mobile device may include data pertaining to a plurality of mobile applications operating on the particular mobile device. The device status may further include at least one of an application push status, a signal strength status, a memory space status, and a usage status. For example, the device status may provide information necessary to determine whether an action, e.g., mobile software change or modification, is necessary (step 307).

If an action or change is necessary, a software application is modified (e.g., loaded, updated, deleted) on one or more of the at least one mobile device corresponding to the at least one user or group of users (step 309). For example, a device manager may push a mobile application to one or more of the mobile devices. In some instances, the step of modifying one or more applications is performed upon a change in the software privilege data for the group of users. For example, the system according to the present invention may automatically detect changes in user or group memberships within the directory service 100 and load, update, and/or delete applications or implement IT policies accordingly. The status of each of the mobile devices may then be updated accordingly, if necessary (step 311).

Although the invention has been described with reference to a particular arrangement of parts, features and the like, these are not intended to exhaust all possible arrangements or features, and indeed many modifications and variations will be ascertainable to those of skill in the art.

What is claimed is:

1. A system for managing mobile electronic devices in a network, comprising:
a plurality of mobile electronic devices;
at least one network processor;
directory service software executing on said at least one network processor for providing user data pertaining to one or more users of said plurality of mobile electronic devices;
at least one mobility server in communication with said at least one network processor; and
device management software executing on said at least one mobility server for receiving the user data and sending at least one mobile application to one or more of said plurality of mobile electronic devices based on the user data.

2. The system according to claim 1, wherein the user data includes mobile application permissions for at least one group of the users.

3. The system according to claim 2, wherein said device management software sends the at least one mobile application to one or more of said plurality of mobile electronic devices corresponding to the at least one group of the users.

4. The system according to claim 2, wherein the mobile application permissions include data indicative of one or more mandatory mobile applications, one or more optional mobile applications and one or more prohibited mobile applications.

5. The system according to claim 2, wherein at least one of the users is a member of two or more groups of users, wherein said directory service software generates resultant mobile application permissions for the at least one of the users based on a dominance of each of the two or more groups.

6. The system according to claim 1, wherein the at least one mobile application includes an executable file.

7. The system according to claim 1, wherein the directory service software is Lightweight Directory Access Protocol directory service software.

8. The system according to claim 1, further comprising:
device agent software executing on each of said plurality of mobile electronic devices for providing device data to said at least one mobility server.

9. The system according to claim 8, wherein the at least one mobile application is sent at a particular time based on the device data.

10. The system according to claim 9, wherein the device data includes a roaming status.

11. The system according to claim 8, wherein said device agent software continuously monitors one or more mobile applications executing on each of said plurality of mobile electronic devices.

12. The system according to claim 8, said device agent software further implementing the at least one mobile application.

13. The system according to claim 8, said directory service further providing at least one device policy to the at least one mobility server, wherein said device management software sends the at least one device policy to the one or more of said plurality of mobile electronic devices, wherein said device agent software implements the at least one device policy.

14. The system according to claim 8, wherein the device data includes a report of mobile applications executing on the mobile electronic device.

15. The system according to claim 8, wherein said device agent software receives a device instruction from said device management software and performs an operation including one of loading the at least one mobile application and deleting a mobile application.

16. The system according to claim 1, said at least one mobility server including at least one applications database including a plurality of mobile applications.

17. The system according to claim 1, further comprising:
application programming interface software executing on said network processor for providing an interface between said directory service software and said device management software.

18. The system according to claim 1, further comprising:
at least one directory database in communication with said at least one network processor, said at least one directory database including at least a portion of the user data.

19. The system according to claim 18, said at least one directory database further including resource data pertaining to at least one of a computer, a printer, and a storage of the network.

20. The system according to claim 18, further comprising:
a network server comprising said at least one network processor and said at least one directory database.

21. A system for managing mobile electronic devices in a network, comprising:
a plurality of mobile electronic devices, each of said mobile electronic devices including device agent software for providing device data;
at least one processor;
directory service software executing on said at least one processor for providing user data pertaining to users of said plurality of mobile electronic devices; and
device management software executing on said at least one processor for receiving the user data and sending at least one device policy to one or more of said plurality of mobile electronic devices based on the user data.

22. The system according to claim 21, wherein the device agent software provides for at least one of storing the device policy on a corresponding one of said plurality of mobile electronic devices and implementing the device policy on the corresponding one of said plurality of mobile electronic devices.

23. The system according to claim 21, wherein said device management software further sends at least one application to the one or more of said plurality of mobile electronic devices based on the user data.

24. The system according to claim 21, wherein said device agent software receives said at least one device policy and continuously monitors one or more mobile applications for compliance with the at least one device policy.

25. The system according to claim 21, wherein said at least one processor includes a network processor and a device management processor, said directory service software executing on the network processor and said device management software executing on the device management processor.

26. The system according to claim 25, further comprising:
application programming interface software executing on at least one of the network processor and the device management processor for providing an interface between said directory service software and said device management software.

27. A method of managing mobile electronic devices in a network, comprising the steps of:
receiving user data from a directory service, the user data pertaining to at least one mobile electronic device user;
determining mobile application privileges for the at least one user based on the user data;
determining a device status of at least one mobile electronic device corresponding to the at least one user; and
modifying one or more applications on the at least one mobile electronic device based on the mobile application privileges and the device status.

28. The method according to claim 27, wherein the mobile application privileges include data indicative of one or more mandatory mobile applications, one or more optional mobile applications and one or more prohibited mobile applications.

29. The method according to claim 27, wherein said step of modifying one or more applications includes one of updating, loading and deleting the one or more applications.

30. The method according to claim 27, wherein said step of modifying one or more applications includes pushing an application to the at least one mobile electronic device.

31. The method according to claim 27, wherein the user data pertains to at least one group of mobile electronic device users and wherein said step of modifying one or more applications includes modifying one or more applications on a plurality of mobile electronic devices corresponding to the group of users.

32. The method according to claim 27, wherein said step of modifying one or more applications is performed upon a change in the mobile application privileges.

33. The method according to claim 27, wherein the device status includes a report of one or more mobile applications operating on the at least one mobile electronic device.

34. The method according to claim 27, wherein the device status includes at least one of an application push status, a signal strength status, a memory space status, and a usage status.

35. The method according to claim 27, wherein said step of determining a device status includes sending a device query and receiving the device status from a device agent application of the at least one mobile electronic device.
